(19) United States
(12) Patent Application Publication
(10) Pub. No.: US 2019/0129070 A1
(43) Pub. Date: May 2, 2019

(54) LENS AND METHOD FOR MAKING THE SAME

(71) Applicant: HON HAI PRECISION INDUSTRY CO., LTD., New Taipei (TW)

(72) Inventor: HSIU-WEN CHIEN, New Taipei (TW)

(21) Appl. No.: 15/853,865

(22) Filed: Dec. 25, 2017

(30) Foreign Application Priority Data
Oct. 31, 2017 (TW) 106137675

(51) Int. Cl. G02B 1/14; G02B 1/113; B29C 45/26

(52) U.S. Cl. CPC G02B 1/14; B29C 45/26; G02B 1/113

(57) ABSTRACT

An uncoated lens with anti-reflective, non-fouling, and water-repelling characteristics comprises a lens body and nanosized structures. The lens body comprises a front surface and a rear surface. The front surface and the rear surface are opposite to each other. The nanosized structures are positioned on the front surface. The nanosized structures and the lens body are integrally formed by a molding process. The nanosized structures comprise a plurality of protrusions. A size of each protrusion is smaller than a wavelength of visible light.

### FIELD

The subject matter relates to a lens and a method for making the same.

### BACKGROUND

In general, both surfaces of spectacle lenses are coated with a hard coating, an anti-reflective layer, and an anti-fouling layer. The anti-reflective layer is made of inorganic chemical materials. The materials have different refractive indexes, and are formed on the surfaces of the lens by a vacuum plating machine.

However, the vacuum plating machine is large which leads to large power consumption. Furthermore, the anti-reflection layer is a multilayer structure, which involves a long processing time. Improvements in the art are preferred.

### BRIEF DESCRIPTION OF THE DRAWINGS

Implementations of the present technology will now be described, by way of example only, with reference to the attached figures, wherein:

FIG. 1 is a diagram of a lens, in accordance with an exemplary embodiment of the present application.

FIG. 2 is a enlarged diagram of part of the lens of FIG. 1.

FIG. 3 is a sectional diagram of nanosized structures of the lens of FIG. 2.

FIG. 4 is another sectional diagram of nanosized structures of the lens of FIG. 2.

FIG. 5 is a flowchart of a method for making the lens of FIG. 1.

FIG. 6 is a sectional diagram of a mold for making the lens of FIG. 1.

FIG. 7 is another sectional diagram of a mold for making the lens of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein can be practiced without these specific details.

In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts may be exaggerated to better illustrate details and features of the present disclosure.

One definition that applies throughout this disclosure will now be presented.

The term “substantially” is defined to be essentially conforming to the particular dimension, shape, or other feature that the term modifies, such that the component need not be exact. For example, “substantially rectangular” means that the object resembles a rectangle, but can have one or more deviations from a true rectangle.

The term “comprising,” when utilized, means “including, but not necessarily limited to”; it specifically indicates open-ended inclusion or membership in the so-described combination, assembly, series, and the like.

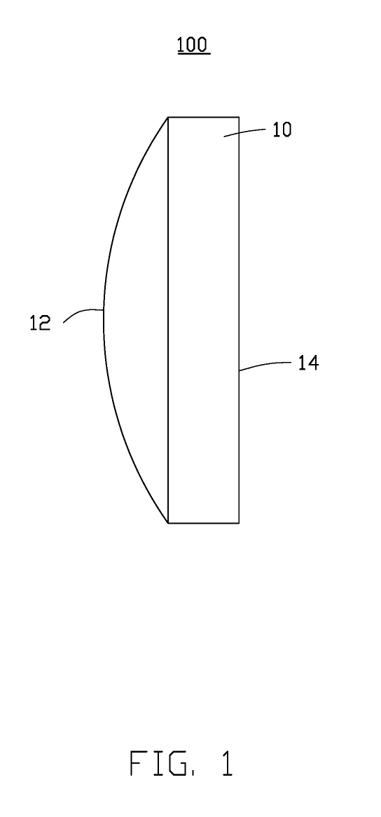

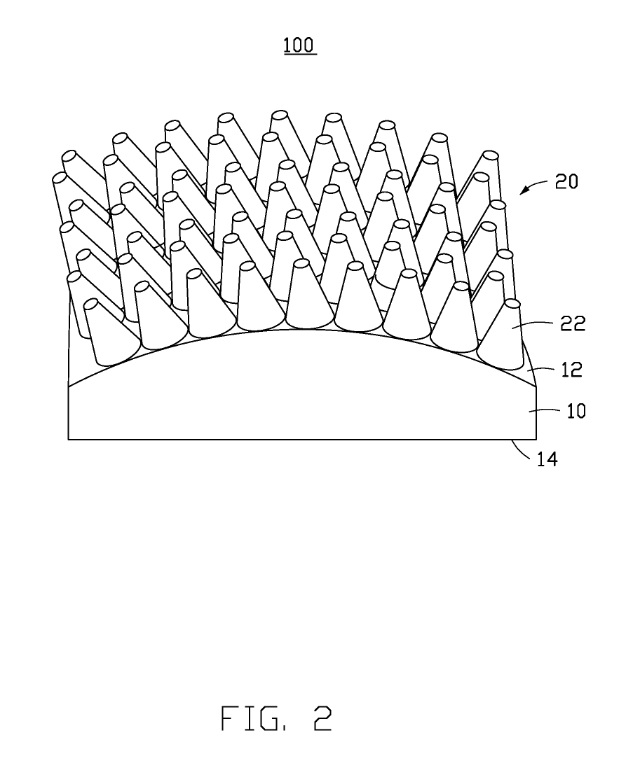

Referring to FIGS. 1 to 2, a lens 100 is made of a transparent material such as a Colombian resin (CR39), glass, crystal, or plastic. In the exemplary embodiment, the lens 100 is a spectacle lens. The lens 100 comprises a lens body 10 and a plurality of nanosized structures 20. The nanosized structures 20 are positioned on the lens body 10. The nanosized structures 20 and the lens body 10 are integrally formed. The lens body 10 comprises a front surface 12 and a rear surface 14, which are opposite to each other. In the exemplary embodiment, the front surface 12 has an curvature, so that the lens body 10 can have an optical power. The rear surface 14 is flat. The nanosized structures 20 are positioned on the front surface 12.

Referring to FIG. 2, the nanosized structures 20 comprises a plurality of protrusions 22. The protrusion 22 is smaller than the wavelength of visible light in size.

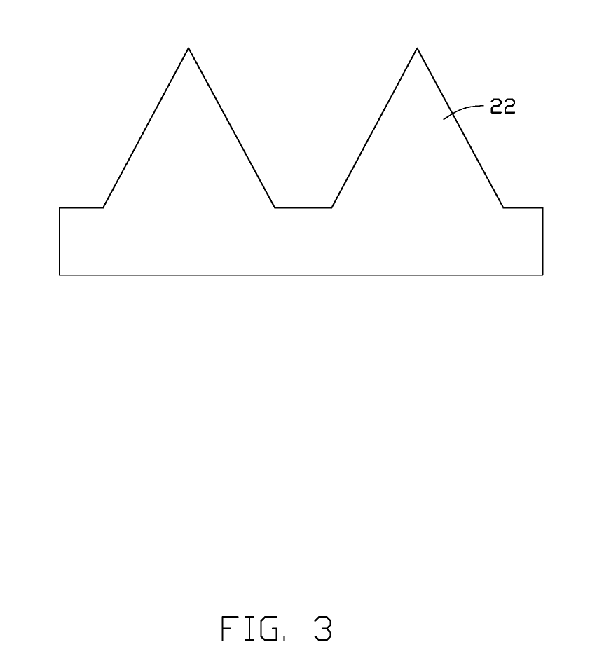

Referring to FIG. 3, in the exemplary embodiment, the protrusions 22 are cone-shaped. The shapes and the sizes of the protrusions 22 are the same. The protrusions 22 are uniformly positioned on the front surface 12.

Each protrusion 22 has a height in a range of 45 nanometers to 550 nanometers. A diameter of a bottom of each protrusion 22 ranges from 35 nanometers to 155 nanometers. The bottom of each protrusion 22 is connected to the front surface 12. A distance between two adjacent protrusions 22 ranges from 12 nanometers to 330 nanometers.

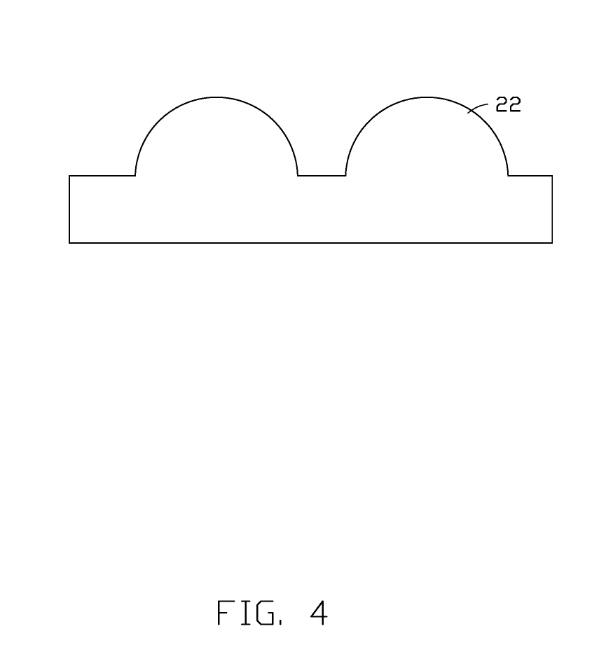

Referring to FIG. 4, in another exemplary embodiment, the protrusions 22 are hemispherical. The shapes and the sizes of the protrusions 22 are the same. The protrusions 22 are uniformly positioned on the front surface 12.

A height between a vertex of each protrusion 22 and the front surface 12 ranges from 45 nanometers to 550 nanometers. A diameter of a bottom of each protrusion 22 ranges from 35 nanometers to 155 nanometers. The bottom of each protrusion 22 is connected to the front surface 12. A distance between two adjacent protrusions 22 ranges from 12 nanometers to 330 nanometers.

In other exemplary embodiments, the nanosized structures 20 can also be positioned on the rear surface 14.

Since the front surface 12 is covered by the nanosized structures 20, the front surface 12 presents a superhydrophobic property. Thus, the front surface 12 has self-cleaning and anti-fouling properties.

Furthermore, since the size of each protrusion 22 is smaller than the wavelength of the visible light, the lens 100 has an anti-reflective property, which is similar to compound eyes of insects. The surface of each compound eye of insects has nanosized protrusions, and a size of each protrusion is less than the wavelength of light, thus the compound eye has a low reflectivity. When a size of the texture of surface the material is smaller than the wavelength of the light, the refraction of the light exhibits a continuous change (also known as a graded index) on the surface of the material. The continuous change results in less reflection and greater absorption of light from all directions.

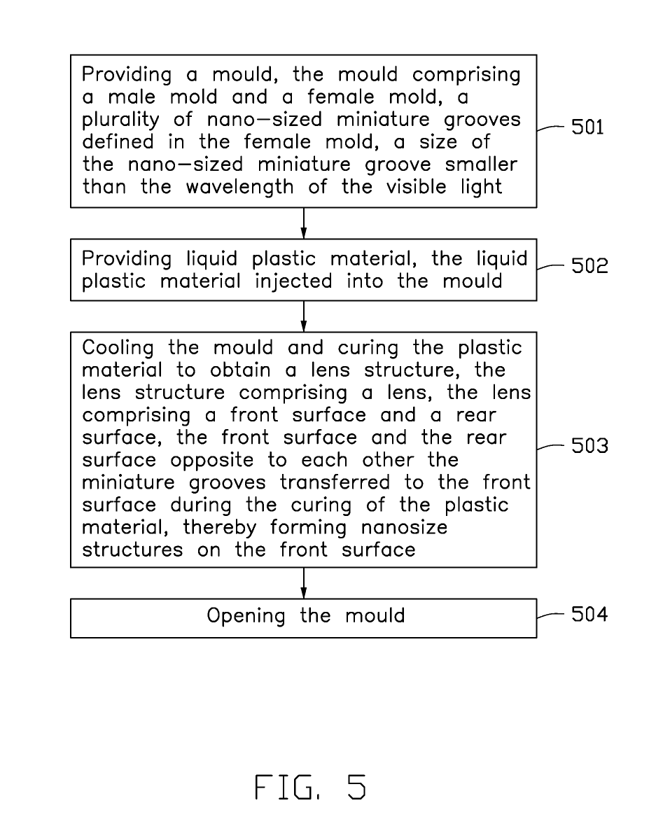

Referring to FIG. 5, the exemplary embodiment also provides a method for manufacturing a lens 100.

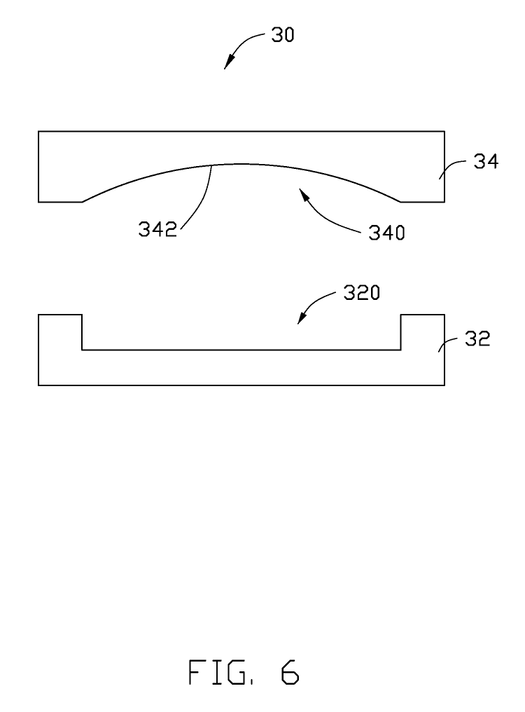

At block 501, referring to FIG. 6, a mold 30 is provided. The mold 30 comprises a male mold 32 and a female mold 34. The male mold 32 is positioned opposite to the female mold 34. The shape and the size of the male mold 32 match the shape and the size of the female mold 34. In the exemplary embodiment, the male mold 32 and the female mold 34 are cubic. A first groove 32 is defined in the male mold 32. The first groove 320 is cylindrical. A second groove 340 is defined in the female mold 34. The second groove 340 corresponds to the first groove 320. The second groove 340 is a circular arc groove. The second groove 340 comprises an arc surface 342. The arc surface 342 is positioned on the bottom surface of the second groove 340.

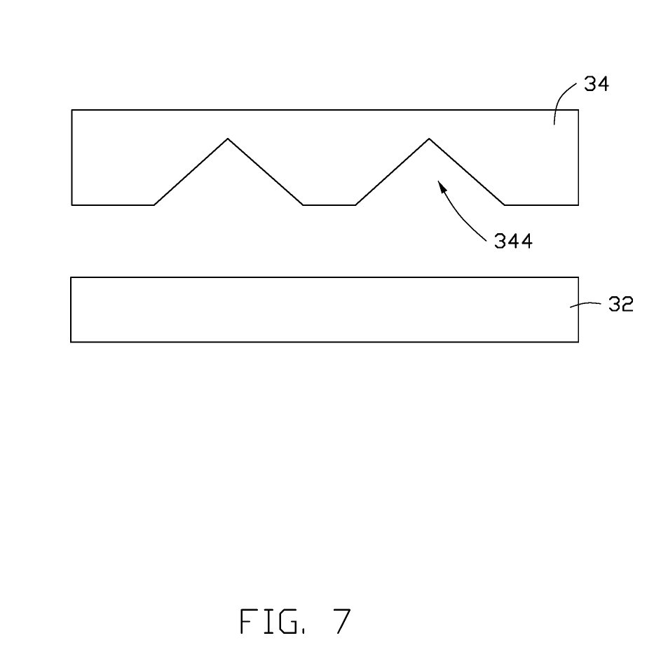

Referring to FIGS. 6 to 7, a plurality of nanosized grooves 344 is defined in the arc surface 342. A size of the nanosized groove 344 is smaller than the wavelength of the visible light. Shapes and sizes of grooves 344 are same. The grooves 344 are uniformly positioned on the arc surface 342. In the exemplary embodiment, the grooves 344 are cone-shaped. Each groove 344 has a depth in the range of 45 nanometers to 550 nanometers, a diameter of a notch of the groove 344 is in the range of 35 nanometers to 155 nanometers, and the distance between two adjacent grooves 344 is in the range of 12 nanometers to 330 nanometers.

In other exemplary embodiments, the grooves 344 are hemispherical, each groove 344 has a depth in the range of 45 nanometers to 550 nanometers, a diameter of a notch of the groove 344 is in the range of 35 nanometers to 155 nanometers, and the distance between two adjacent grooves 344 is in the range of 12 nanometers to 330 nanometers.

At block 502, liquid plastic material (not shown) is provided. The liquid plastic material is injected into the mold 30.

At block 503, the mold 30 is cooled and the plastic material is cured to obtain the lens 100.

The lens 100 comprises a lens body 10. The lens body comprises a front surface 12 and a rear surface 14. The front surface 12 and the rear surface 14 are opposite to each other. The grooves 344 are transferred to the front surface 12 during the curing of the plastic material, thereby forming the nanosized structures 20 on the front surface 12;

At block 504, the lens 100 is separated from the mold 30.

Referring to FIG. 2, the lens 100 comprises the lens body 10 and the nanosized structure 20. The lens body 10 comprises a front surface 12 and a rear surface 14. The front surface 12 and the rear surface 14 are opposite to each other. The nanosized structures 20 are positioned on the front surface 12.

In other exemplary embodiments, a plurality of nanosized grooves 322 (not shown) is defined in a bottom surface of the first groove 320. Shapes and sizes of grooves 322 are same. The grooves 322 are uniformly positioned on a bottom of the first groove 320. Similar to the grooves 344, the grooves 322 can be conical or hemispherical. Each groove 322 has a depth in the range of 45 nanometers to 550 nanometers, a diameter of a notch of the groove 322 is in the range of 35 nanometers to 155 nanometers, and a distance between two adjacent grooves 322 is in the range of 12 nanometers to 330 nanometers.

The method for manufacturing the lens 100 directly creates the nanosized structure 20 on the lens body 10. The nanosized structure 20 comprises a plurality of protrusions 22, the size of the protrusion 22 is smaller than the wavelength of the visible light, thus the nanosized structure 20 has an anti-reflective property. This simplifies the manufacturing process of the anti-reflection layer and reduces the manufacturing cost of the lens 100. Since at least the front surface 12 of the lens body 10 has the nanosized structures 20, the nanosized structures 20 have a superhydrophobic property and an anti-fouling property.

The embodiments shown and described above are only examples. Many details are often found in the art such as the other features. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A lens comprising:
a lens body comprising a front surface and a rear surface, the front surface and the rear surface opposite to each other; and
a plurality of nanosized structures positioned on the front surface;
wherein the nanosized structures and the lens body are integrally formed, the nanosized structures comprise a plurality of protrusions, a size of each protrusion is smaller than a wavelength of visible light.

2. The lens of claim 1, wherein shapes and sizes of the protrusions are the same, and the protrusions are uniformly positioned on the front surface.

3. The lens of claim 2, wherein the protrusions are cone-shaped, each protrusion has a height in a range of 45 nanometers to 550 nanometers, a diameter of a bottom of each protrusion ranges from 35 nanometers to 155 nanometers, the bottom is connected to the front surface, a distance between two adjacent protrusions ranges from 12 nanometers to 330 nanometers.

4. The lens of claim 2, wherein the protrusions are hemispherical, a height between a vertex of each protrusion and the front surface ranges from 45 nanometers to 550 nanometers, a diameter of a bottom of each protrusion ranges from 35 nanometers to 155 nanometers, the bottom is connected to the front surface, a distance between two adjacent protrusions ranges from 12 nanometers to 330 nanometers.

5. The lens of claim 1, wherein the front surface is curved.

6. The lens of claim 1, wherein the nanosized structures are also positioned on the rear surface.

7. A method for making a lens comprising:
providing a mold, the mold comprising a male mold and a female mold, a plurality of nanosized grooves defined in the female mold, a size of the nanosized groove smaller than a wavelength of visible light;
providing a liquid plastic material and injecting the liquid plastic material into the mold;
cooling the mold, which causes the plastic material to be cured to obtain the lens, the lens comprising a lens body, the lens body comprising a front surface and a rear surface, the front surface and the rear surface opposite to each other, the grooves transferred to the front surface during the curing of the liquid plastic material, thereby forming a plurality of nanosized structures on the front surface;
separating the lens from the mold.

8. The method of claim 7, wherein shapes and sizes of grooves are the same, the grooves are uniformly positioned on the female mold.

9. The method of claim 8, wherein the grooves are cone-shaped, each groove has a depth in the range of 45 nanometers to 550 nanometers, a diameter of a notch of the groove is in the range of 35 nanometers to 155 nanometers, and the distance between two adjacent grooves is in the range of 12 nanometers to 330 nanometers.

10. The method of claim 8, wherein the grooves are hemispherical, each groove has a depth in the range of 45 nanometers to 550 nanometers, a diameter of a notch of the groove is in the range of 35 nanometers to 155 nanometers, and the distance between two adjacent grooves is in the range of 12 nanometers to 330 nanometers.

11. The method of claim 7, wherein a first groove is defined in the male mold, a second groove is defined in the female mold, the second groove cooperates with the first groove, a bottom of the second groove is an arc surface, and the grooves are formed on the arc surface.

12. The method of claim 11, wherein the grooves are also defined in a bottom of the first groove.
